(19) United States
(12) Patent Application Publication
(10) Pub. No.: US 2019/0042116 A1
(43) Pub. Date: Feb. 7, 2019

(54) TECHNIQUES FOR PREVENTING MEMORY CORRUPTION

(71) Applicant: INTEL CORPORATION, Santa Clara, CA (US)

(72) Inventors: KEKAI HU, Portland, OR (US); KE SUN, PORTLAND, OR (US); RODRIGO BRANCO, HILLSBORO, OR (US)

(73) Assignee: INTEL CORPORATION, Santa Clara, CA (US)

(21) Appl. No.: 15/858,170

(22) Filed: Dec. 29, 2017

(51) Int. Cl. G06F 3/06

(52) U.S. Cl. CPC G06F 3/0622; G06F 3/0631; G06F 3/0673; G06F 3/0637; G06F 3/0644

(57) ABSTRACT

Techniques and apparatus for preventing memory corruption events, such as use-after-free vents, are described. In one embodiment, for example, an apparatus at least one memory comprising at least one memory unit, and logic coupled to the at least one memory, the logic to implement a memory operation verification process to allocate a memory element in the at least one memory unit, generate a pointer for the memory element, determine a memory identifier, and assign the memory identifier to the memory element and the pointer. Other embodiments are described and claimed.

### TECHNICAL FIELD

Embodiments described herein generally relate to computer security and processor architecture and, more specifically, to preventing memory corruption and attacks.

### BACKGROUND

Computing systems are vulnerable to multiple types of memory corruption that may be associated with malicious software. Use-after-free is a class of memory corruption bug that has been extensively abused to compromise security properties of a system. In general, a use-after-free corruption bug occurs when a program dereferences a pointer after the memory block it pointed to has been freed. The use of previously freed memory can have any number of adverse consequences, ranging from the corruption of valid data to the execution of arbitrary or even malicious code, depending on the instantiation and timing of the flaw. Conventional solutions used to address use-after-free corruption have high miss rates and/or excessive performance overhead.

### BRIEF DESCRIPTION OF THE DRAWINGS

FIG. 1 illustrates an embodiment of a first operating environment.

FIG. 2 illustrates an embodiment of a second operating environment.

FIGS. 3A and 3B illustrate an embodiment of a third operating environment.

FIG. 4 illustrates an embodiment of a first logic flow.

FIG. 5 illustrates an embodiment of a second logic flow.

FIG. 6 illustrates an example of a storage medium.

FIG. 7 illustrates an embodiment of a computing architecture.

### DETAILED DESCRIPTION

Various embodiments may be generally directed to computing devices and processes for preventing memory corruption, including memory corruption based on a use-after-free vulnerability. In some embodiments, each allocated memory element (for example, a chunk or block of memory) may be assigned a unique memory identifier. A pointer (or pointer structure) for the memory element may be associated with a memory identifier, which matches the memory element memory identifier. A memory operation (for instance, dereferencing the pointer) involving a pointer may determine whether the memory identifier associated with the pointer (or pointer structure) matches the memory identifier assigned to the memory element that is the subject of the memory operation. The memory operation may be completed responsive to the memory identifier of the pointer (or pointer structure) matching the memory identifier of the memory element (for example, data stored in the memory element may be returned in the dereferencing operation). If the memory identifier of the pointer does not match the memory identifier of the memory element, the memory operation will not be completed and an exception may be generated.

In general, a use-after-free vulnerability involves a program dereferencing a pointer after the memory element the pointer pointed to has been freed. Data corruption may occur due to the computing device's reuse of the freed memory. For example, the memory may be allocated to another pointer at some point after it has been freed (the pointer may be of the same type or of a different type). The original pointer to the freed memory is used again and points to somewhere within the new allocation, the contents of which might be controlled by malicious software. As the data is changed, it corrupts the memory referenced by the new pointer, which results in data corruption and undefined behavior (which may compromise system security).

Accordingly, the use-after-free vulnerability may be used to attack a computing device via by computer viruses, malware, and/or the like. For example, malicious software may use a freed pointer to change the value stored in a portion of memory associated with a second pointer. An attacker may have the ability to read from or write to arbitrary locations in memory via the freed pointer to gain the ability to execute code on the computer system.

For example, a memory device may include a portion of memory dedicated to various memory units, such as heap memory that includes a plurality of heap blocks or chunks. A first pointer may point to a memory block of the heap memory. The memory block may store data of a first type and a value of 123. The first memory block may be freed and the first pointer becomes a legacy pointer. A second pointer is instantiated that points to the memory block, now storing data of a second type and a value of ABC. A use-after-free vulnerability may arise if the first pointer is used again while still pointing to the memory block now pointed to by the second pointer, such that the first pointer and the second pointer point to the same portion of memory. The first pointer may change the value stored in the memory block, for example, to a first data type with a value of 456. When the second pointer is used, instead of accessing data of the second type with a value of ABC, the second pointer will access data of the first data type with a value of 456.

In another example, malicious software may attempt to control the second pointer to interfere with or otherwise corrupt operation of the first pointer. For instance, the freed first pointer may be the target of the malicious attack. For example, the first pointer may be associated with a memory block having a value of 123. Software may be operative to perform (or not perform) a function based on the content of the memory block (for instance, if value=123, do not perform function x). A malicious attack may control the second pointer to modify the content of the memory block associated with the first pointer, for example, to have a value of ABC. Accordingly, the software may perform (or not perform) a function because the value is not 123 (for instance, the software may perform function x because the value≠123).

Accordingly, data corruption may occur and/or a malicious software attack may be initiated (for example, an attacker may gain the ability to read/write to various memory locations).

Therefore, in order to exploit a use-after-free vulnerability, an attacker needs a legacy pointer pointing to a memory region that has already been freed. With the allocation of a new memory block on the same region, the attacker can control the data where the legacy pointer is pointing to, in which case the attacker-controlled data will be consumed instead of the original data when the program reuses the pointer, assuming that the pointer is still pointing to the original heap block.

Conventional use-after-free vulnerability prevention solutions have been directed at the software level. A first conventional technique generally involves preventing coding errors or weaknesses that lead to use-after-free vulnerabilities (for example, statically at compile time or dynamically at runtime). However, such techniques have severe limitations and cannot cover all the possible use-after-free cases. A typical example of preventing use-after-free exploitation is to set a pointer to NULL when it's freed such that dereferencing a freed pointer will not re-access the original memory location. But this protection does not work in most computing environments, particularly complex architectures. For example, the following pseudocode (1) may demonstrate setting a pointer p1 to null after freeing the pointer:

$${char}^{*} p 1 = ( {char}^{*} ) malloc ( SIZE ) ; \\ {char}^{*} p 2 = p 1 ; \\ free ( p 1 ) ; \\ p 1 = NULL . \qquad ( 1 )$$

Although pointer p1 is set to NULL after being freed, since pointer p2 also points to the same freed memory area, p2 will still trigger use-after-free vulnerability if an attacker re-allocates new memory contents to this memory area before p2 is used.

A second conventional technique generally involves preventing exploitation of the use-after-free vulnerability so that even though some use-after-free bugs may exist on a system, attackers cannot utilize them. For example, certain use-after-free mitigation methods protect against use-after-free vulnerabilities using software-level enhancements to reduce the chance of use-after-free exploitability, (e.g., Microsoft® MemGC (memory garbage collector) that only frees protected objects when no references exist on the stack, heap or registers). Although these mitigations may somewhat reduce the chances of exploitation of use-after-free vulnerabilities, they bring significant performance overheads that have material negative impact on the user experiences of a program. For example, Microsoft® MemGC is considered as one of the main reasons why the Microsoft® Internet Explorer® (IE) browser is much slower than its competitors because every time a protected objective/pointer is freed, MemGC requires complete software level scans of related stacks, heaps and registers. As such, in an application as big as an IE browser, with thousands of protected objectives/pointers, these software level protections bring a huge overhead.

Hardware-based use-after-free vulnerability prevention solutions, for example, use of protection keys, are generally configured to detect non-intentional bugs. Such hardware-based solutions may be operative to prevent linear heap overflows, but are not effective at preventing use-after-free cases.

Accordingly, some embodiments may include a memory access verification process operative to provide a memory identifier-based solution to prevent exploitation of use-after-free vulnerabilities that may exist on a computing system. Compared to existing solutions, that either have high miss rate or high-performance overhead, the memory access verification process may provide a high detection rate (up to 100% if fully enabled) that can significantly reduce or even eliminate UAF exploitability, while also exhibiting very low overhead in terms of both performance and memory footprint. In addition, the memory access verification process according to some embodiments may be flexible enough to be implemented in software, hardware, or a combination of software and hardware, for example, depending on the consumer requirements, thus achieving a good balance between high performance and low implementation complexity.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, known structures and devices are shown in block diagram form in order to facilitate a description thereof. The intention is to provide a thorough description such that all modifications, equivalents, and alternatives within the scope of the claims are sufficiently described.

Additionally, reference may be made to variables, such as, “a”, “b”, “c”, which are used to denote components where more than one component may be implemented. It is important to note, that there need not necessarily be multiple components and further, where multiple components are implemented, they need not be identical. Instead, use of variables to reference components in the figures is done for convenience and clarity of presentation.

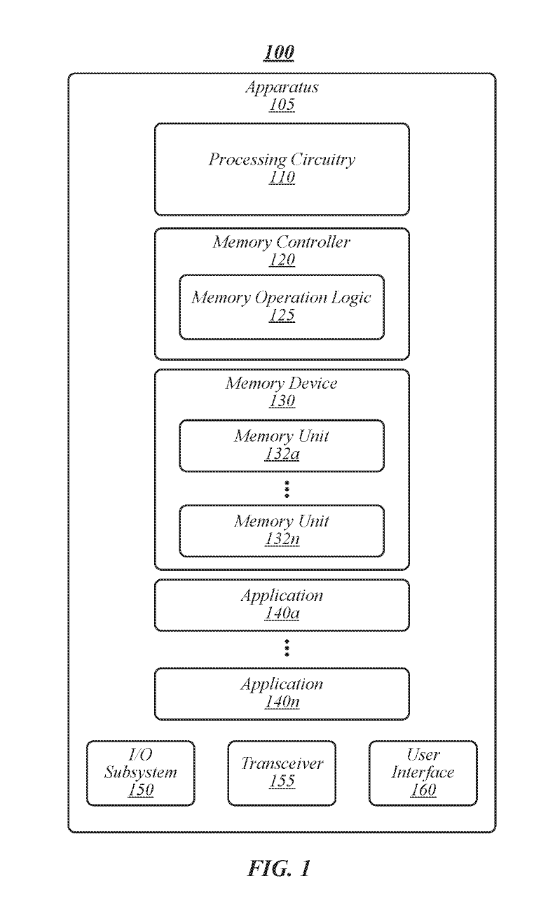

FIG. 1 illustrates an example of an operating environment 100 that may be representative of various embodiments. The operating environment 100 depicted in FIG. 1 may include an apparatus 105 having a processing circuitry 110, a memory controller 120, a memory device 130, an I/O subsystem 150, a transceiver 155, and/or a user interface 160. Apparatus 105 may be or may include a computing device, such as a laptop computer, a personal computer (PC), a workstation computer, a tablet, a personal digital assistant (PDA), a smartphone, a phablet, an image capture device, a server, a networking device, and/or the like.

I/O subsystem 140 may be embodied as circuitry and/or other components operative to facilitate I/O operations with processing circuitry 110, memory 115, and/or other components of apparatus. For example, I/O subsystem 140 may be embodied as, or otherwise include, memory controller hubs, I/O control hubs, firmware devices, communication links (for instance, point-to-point links, bus links, wires, cables, light guides, printed circuit board traces, and/or the like), and/or other components and subsystems to facilitate input/output operations. In some embodiments, I/O subsystem 140 may form a portion of a system-on-a-chip (SoC) and may be incorporated, along with processing circuitry 110, memory 115, and other components of apparatus, on a single integrated circuit chip. User interface 180 may provide an interface for user interaction with apparatus 105. For example, user interface 180 may include various input devices, such as a mouse, keyboard, touchscreen, and/or the like.

Processing circuitry 110 may be communicatively coupled to memory controller 120, memory device 130, I/O subsystem 150, transceiver 155, and/or user interface 160. In various embodiments, processing circuitry 110 may include a central processing unit (CPU) and/or may be implemented on or as a SoC. Processing circuitry 110 may include and/or may access various logic for performing processes according to some embodiments. As used in this application, the terms “controller,” “logic, “component,” “layer,” “system,” “circuitry,” “decoder,” “encoder,” and/or “module” are intended to refer to a computer-related entity, either hardware, a combination of hardware and software, software, or software in execution, examples of which are provided by the exemplary computing architecture 700. For example, a logic, a controller, a circuitry, or a layer may be and/or may include, but are not limited to, a process running on a processor, a processor, a hard disk drive, multiple storage drives (of optical and/or magnetic storage medium), an object, an executable, a thread of execution, a program, a computer, hardware circuitry, integrated circuits, a controller, application specific integrated circuits (ASIC), programmable logic devices (PLD), digital signal processors (DSP), field programmable gate array (FPGA), a system-on-a-chip (SoC), memory units, logic gates, registers, semiconductor device, chips, microchips, chip sets, software components, programs, applications, firmware, software modules, computer code, combinations of any of the foregoing, and/or the like.

Memory controller 120 may be operably coupled to memory device 130. In some embodiments, memory controller 120 and/or memory device 130 may be integrated with processing circuitry. For instance, a SoC may include memory controller 120 and/or memory device 130. In various embodiments, memory controller 120 may operate to control various aspects of memory device 130, such as performing memory operations for memory device 130. Memory operations may include, without limitation, read operations, write operations, memory allocation operations, memory freeing operations, garbage collection operations, and/or the like. For example, memory controller 120 may allocate memory units or elements (for instance, contiguous blocks or chunks) in memory device 130. Memory unit 130 may include various types of computer-readable storage media and/or systems in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

In some embodiments, memory device 130 may be portioned into one or more memory units 132a-n. For example, memory device 130 may be configured as a heap memory for data and/or memory operations associated with execution of applications 140a-n. In general, heap memory is an area of reserved memory that a program or application can use to store data in a variable amount. For example, memory units 132a-n in the form of heap memory may be used when applications 140a-n are running. For example, an application may receive different amounts or types of data for processing (such as from different users) and store the data in the heap memory. In some embodiments, the memory blocks may have different sizes. In other embodiments, the memory blocks of the can be a same pre-defined size, such as 64 bytes (B) or 32 B.

Memory operation logic 125 may operate to manage memory operations for memory controller 120. In some embodiments, memory operation logic 125 may provide a memory operation verification process to prevent or eliminate certain types of memory corruption and/or memory attacks. More specifically, memory operation verification process according to some embodiments may reduce, prevent, or completely eliminate use-after-free events with memory device 130. Although memory operation logic 125 is depicted as arranged in or otherwise associated with memory controller 120, embodiments are not so limited, as memory operation logic may be a standalone logic, a logic of processing circuitry 110, a logic of a SoC, a logic of memory device 130, and/or the like.

In some embodiments, memory operation logic 125 may perform a memory operation verification process that includes using a memory identifier per pointer used to access memory in memory device 130. In various embodiments, the memory identifier may be used to identify a memory unit, element, region, or other portion of memory device 130 storage corresponding to the pointer. In some embodiments, the memory identifier may be or may include a value, number, alphanumeric character or string, binary value, integer value, floating point value, and/or the like. For example, at least one memory unit 132a-n may be generated, allocated, or otherwise initiated for execution of an application 140a-n. For instance, a new heap memory allocation may be initiated responsive to launching an application. The memory ID may be initialized to a starting value, such as zero for integer values. In various embodiments, each region of a memory unit 132a-n may be assigned a memory identifier, starting with the starting value, and each subsequent memory region being assigned a memory identifier increased monotonically or by some other increment step process. In some embodiments, the memory identifier may be a random number and not an increment based on a previously-assigned value. For example, memory unit 132a may be a heap memory. A first heap block may be assigned a memory identifier of 0, a second heap block may be assigned a memory identifier of 1, a third heap block may be assigned a memory identifier of 2, and so on. In exemplary embodiments, the memory identifier of a memory region (for example, a heap block) may be returned to a pointer generated for pointing to the memory region. In various embodiments, memory device 130 and/or one or more of memory units 132a-n may include a memory identifier table operative to store memory identifiers for memory units 132a-n. For example, in a heap memory, the memory identifiers may be stored in a memory identifier table in the heap header. In another example, a dedicated memory identifier table may be included in the heap memory (or other memory unit 132a-n). In some embodiments, the memory identifier table may include a record for each memory identifier and an associated address range.

In some embodiments, memory allocation within a memory unit may generate a pointer variable. For example, in C language-based code or pseudocode, an integer pointer variable may have the form int *ptr, which may be assigned a value of a memory address for variable x, such as in the following pseudocode example: ptr=&x. In some embodiments, each pointer may be associated with the memory identifier of the memory element pointed to by the pointer. For example, in a heap memory, a heap block may have an address of y and a memory identifier of z. A pointer pointing to the heap block may have a value of y and be associated with memory identifier z. The memory identifier may be returned to the pointer in a successful allocation and passed along, for example, in pointer copy or arithmetic operation. In various embodiments, a pointer structure may be generated that includes the original pointer and the memory identifier (MID or HID for a heap identifier). For example, in a 64-bit system, an integer pointer structure may be defined according to the following C language-based pseudocode (2):

$$\begin{matrix}typedef struct mem\_pointer & \\ \{ {int}^{*} original\_pointer ; & \text{/} \text{/} 64 \text{-} bit \\ u int 16 MID ; & \text{//} 64 \text{-} bit \} .\end{matrix} \qquad ( 2 )$$

Referring to pseudocode (1), a pointer structure may be generated responsive to or in connection with a memory allocation request, such as char* p1=(char*)malloc (SIZE) of pseudocode (1). In some embodiments, MID may be stored in multiple locations. For example, MID may be the pointer of mem_pointer, and also stored in a corresponding memory block (for instance, in a table, in memory region, and/or the like).

The example mem_pointer structure may use a 16-bit unsigned integer, which may identify up to 65,536 different memory regions. Although a 16-bit unsigned integer is used as an illustrative example herein, embodiments are not so limited, as any type and/or size of variable capable of operating according to some embodiments may be used for defining a memory identifier. For example, a larger/smaller size variable may be used for the memory identifier (MID) depending on resource availability, security requirements, and/or the like.

In various embodiments, if the memory identifier reaches the maximum value, the memory identifier may restart at the starting value (or “wrap around”). However, using a data type such as a 16-bit unsigned integer has a low probability of causing memory identifier collisions. For example, a 1/65,536 chance of a collision is a low probability. In another example, most use-after-free cases occur in close proximity after the original memory region is freed. Such close timing between an original-freed memory region or unit and a newly-allocated memory unit or region causes the probability of a use-after-free event happening between two memory regions with colliding memory MIDs to be extremely low. In addition, the memory overhead may be very small since it only increases 16 bits per pointer and, in some embodiments, the percentage of total pointers in the overall memory footprint may be small.

In some embodiments, when a pointer is dereferenced for memory unit access, the memory operation verification process may check the memory identifier associated with the pointer against the memory identifier of the memory element (for example, a heap block) the pointer is attempting to access. If the pointer's memory identifier does not match the memory identifier of the memory element, access will be blocked by the memory operation verification process and an exception for illegal memory access may be raised.

For example, referring to pseudocode (1), when the memory allocation occurs responsive to the char*p1=(char*)malloc (SIZE) call, a memory identifier n will be returned to pointer p1 in its memory identifier field. In various embodiments, the memory identifier (or MID variable) may be a 16 bit integer, such that n may have a value between 0 and 65,535 depending on, for example, the number of allocated memory identifiers. In some embodiments, the memory identifier may also be stored for the allocated memory region. In some embodiments, the memory identifier field may include the MID variable of a mem pointer structure according to some embodiments, for example, generated for poinefter p1. When the p1=p2 function of pseudocode (1) executes, the memory identifier of p1 (or the pointer structure of p1) will be copied to the memory identifier of p2 (or the pointer structure of p2), as well as the pointer value (for instance, the memory address for the memory element being pointed to by p2). Accordingly, after the p2=p1 function of pseudocode (1) executes, p2 also has the memory identifier n. After pointer p1 is freed and pointer p2 becomes a legacy pointer, if another memory allocation occurs which allocates the memory element (for example, a heap block) associated with p2 to another pointer p3, pointer p3 and the new memory element will have a new memory identifier that is different from n (for example, n+increment step, such as n+1). In various embodiments, the new memory identifier may update the old memory identifier for this allocated memory region. When p2 is dereferenced during a potential use-after-free event, the memory identifier of p2 (n) will be checked against the memory identifier of the new memory element (n+increment step). Accordingly, the memory identifier of p2 will not match the memory identifier of the new memory element and the use-after-free event may be detected and prevented.

In various embodiments, as described herein above, memory operation logic 125 may be implemented in software, hardware, or a combination of hardware and software. For example, memory operation logic 125 may be implemented in as a compiler-supported hardware solution, for instance, in which a compiler implements the pointer structure and inserts memory identification check points to inform hardware to perform the memory identification, while hardware maintains the memory identification table and carries out the memory identifier check at runtime. In some embodiments, the memory identification table may be stored in one or more local dedicated memory regions, for example, managed by hardware, such as register banks, on-chip SRAM, isolated DRAM, and/or the like, depending on resource availability. In exemplary embodiments, each memory identifier table entry may contain a base address, range, and memory identifier for a memory element (for instance, a heap block region). Accordingly, memory overhead may be minimized as a typical memory identifier table entry for a 64-bit system is only 96 bits per memory element (48 bit base address+32 bit range+16 bit memory uint memory identifier), which is smaller than the size of conventional heap control data structures. In various embodiments, certain portions of the memory operation verification process may be implemented in hardware, such as the memory identifier lookup logic, memory identifier comparison logic, and/or the like, allowing the memory operation verification process to have even better performance metrics than conventional methods.

In some embodiments, the memory operation verification process may be configured to provide different levels of protection. For example, most use-after-free events occur directly after the original memory element (for instance, heap block) is freed. Accordingly, it may not be necessary to check all pointer memory operations (for instance, memory accesses). In some embodiments, the memory operation verification process may enable checking memory identifiers within a verification threshold amount of time after a free event, which will prevent most if not all use-after-free events. In various embodiments, the ability to use and set a verification threshold, for example, as a security option, may provide users with further flexibility and reduce performance overhead.

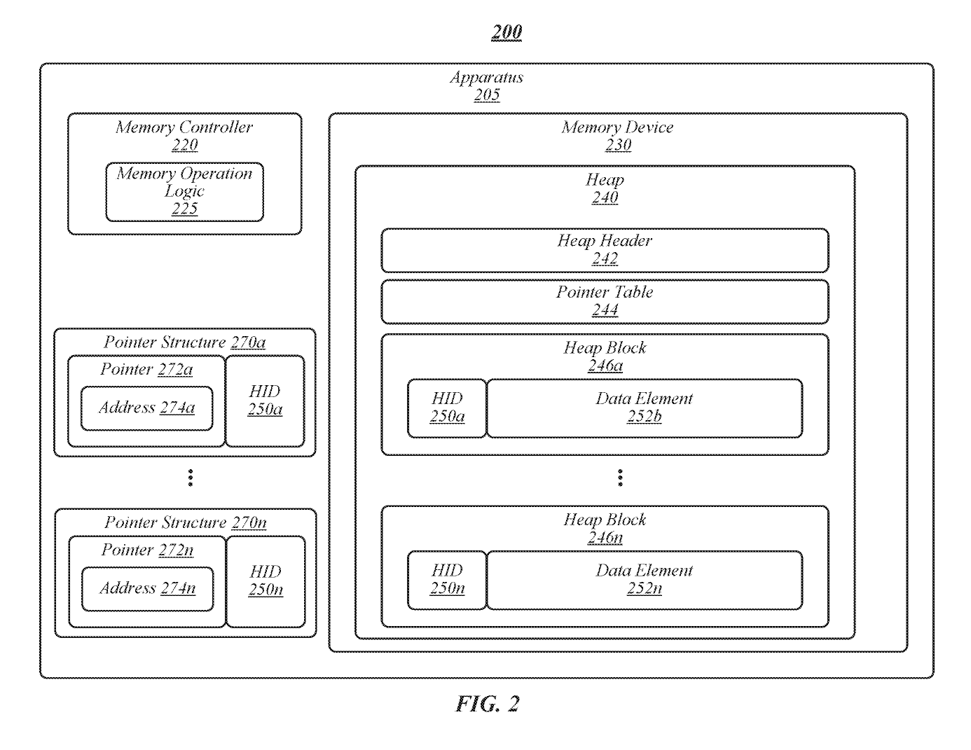

FIG. 2 illustrates an example of an operating environment 200 that may be representative of various embodiments. As shown in FIG. 2, an apparatus 205 may include a memory controller 220 and a memory device. Memory controller 220 may include memory operation logic 225 to perform a memory operation verification process according to some embodiments. Memory device 230 may include a memory unit in the form of a heap 240 having a heap header 242, a pointer table table 244, and a plurality of memory elements (heap blocks or chunks) 246a-n. In some embodiments, heap header 242 may be located at the beginning of heap 240 and may hold certain heap information, such as a size of heap 240, flags for heap 240 that provide certain information to memory controller 220 (or other memory manager), for example, whether the heap is ROM-based.

Pointer table 244 may include a master pointer table, for example used to store pointers to movable heap blocks 246a-n. When memory controller 220 moves a heap block 246a-n, for example to compact heap 240, the pointer for that heap block 246a-n in the pointer table 244 may be updated to the new location of the heap block 246a-n. In some embodiments, if the pointer table 244 becomes full, another may be allocated and its offset is stored in a field of the previous pointer table 244. In some embodiments, pointer table 244 may store memory identifiers (or heap identifiers (HID), in the case of heap memory). In some embodiments, a separate HID table may be maintained and stored, for example, within heap 240.

Each heap block 246a-n may include or be associated with a HID 250a-n and a data element 252, which may include the actual data stored at the heap block 246a-n. A pointer 272a-n may be generated responsive to memory allocation of each heap block 246a-n and may be associated with an address 274a-n of the pointer's 272a-n respective heap block 246a-n. For example, pointer 272a may point to heap block 246a and pointer 272n may point to heap block 246n. In various embodiments, memory operation logic 225 may generate a pointer structure 270a-n for each pointer 272a-n. In exemplary embodiments, pointer structure 270a-n may include a pointer 272a-n and a HID 250a-n that corresponds to the HID 250a-n of the heap block 246a-n pointed to by the pointer 272a-n. For example, pointer 272a may point to heap block 246a and HID 250a of pointer structure 270a may have the same value as HID 250a of heap block 246a (for instance, the HIDs of pointer structure 270a and heap block 246a “match”).

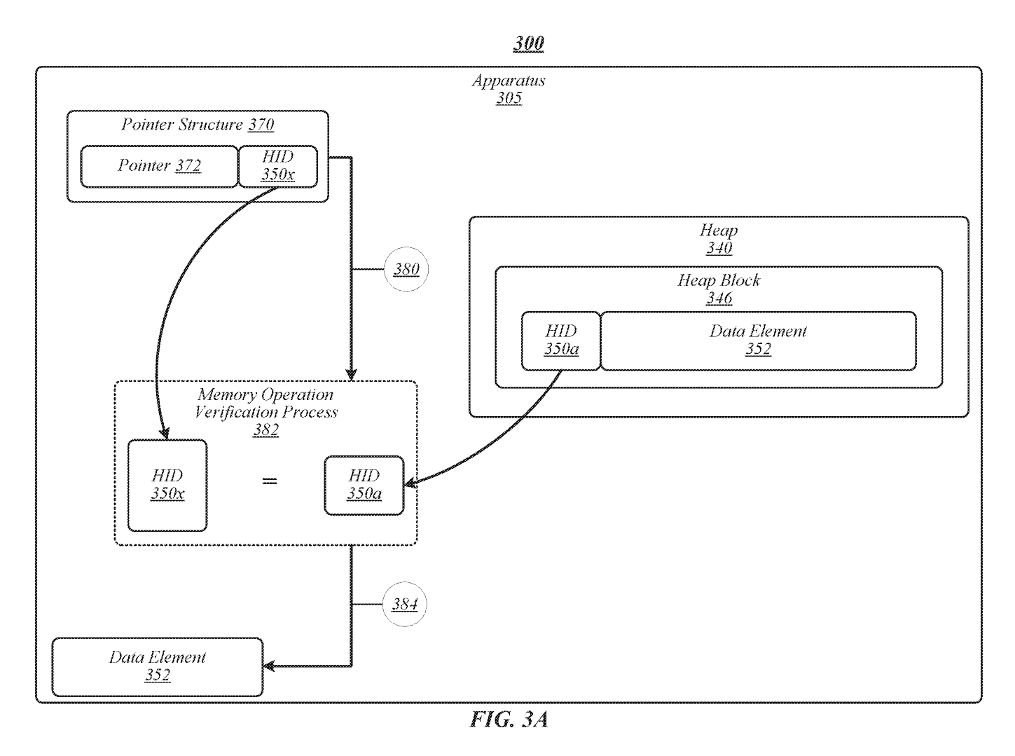

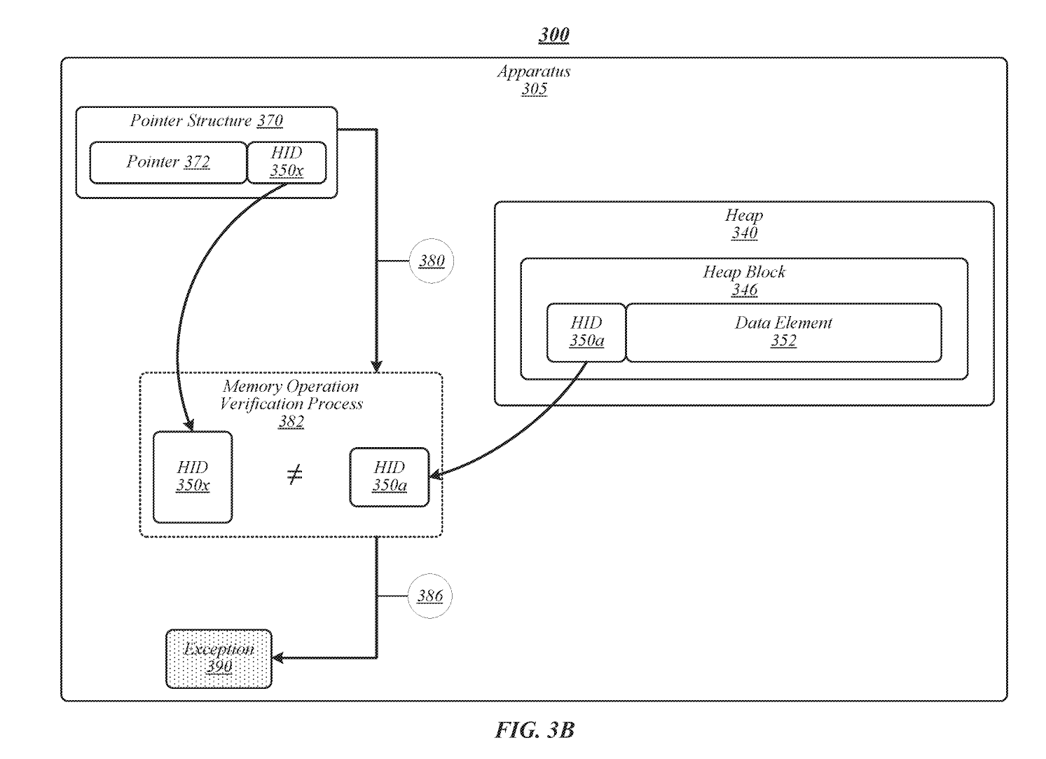

FIGS. 3A and 3B illustrate an example of an operating environment 300 that may be representative of various embodiments. As shown in FIG. 3A, an apparatus 305 may include a heap 340 having a block 346. A memory operation 380 may be triggered to access data in memory element 346 via pointer 372 of pointer structure 370. A memory operation verification process 382 may determine an HID 350x associated with pointer 372. Memory operation verification process 382 may access an HID 350a of heap block 346. In some embodiments, memory operation verification process 382 may determine whether HID 350x matches HID 350a. If HID 350x matches HID 350a, memory operation verification process 382 may determine that memory operation 380 is valid for pointer 372 (for instance, memory operation 380 is not a use-after-free event) and may return 384 data element 352 to the calling function of memory operation 380.

Referring now to FIG. 3B, memory operation verification process 382 has determined that HID 350x does not match HID 350a. Accordingly, memory operation verification process 382 may determine that memory operation 380 may be or may be a part of a use-after-free event. Memory operation verification process 382 may not provide access to heap block 346 and, instead, may generate a memory corruption event 386, which may include generating an exception 390. Apparatus 305, for example, through on operating system (OS) thereof, may handle exception 390. In this manner, malicious and/or corrupt access to heap 340 may be prevented, such as via a use-after-free event.

Included herein are one or more logic flows representative of exemplary methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, hardware, or any combination thereof. In software and firmware embodiments, a logic flow may be implemented by computer executable instructions stored on a non-transitory computer readable medium or machine readable medium, such as an optical, magnetic or semiconductor storage. The embodiments are not limited in this context.

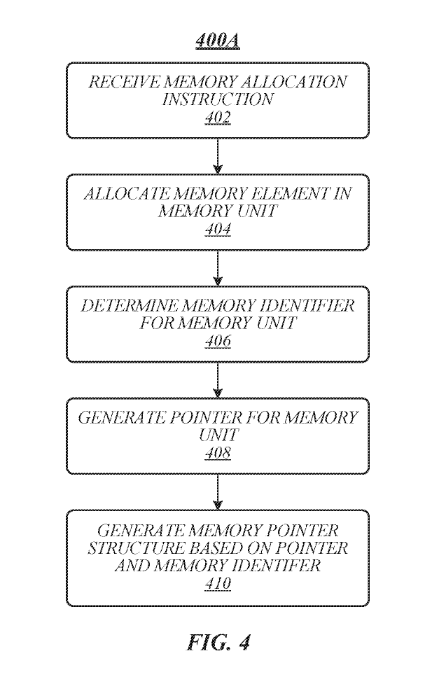

FIG. 4 illustrates an embodiment of a logic flow 400. Logic flow 400 may be representative of some or all of the operations executed by one or more embodiments described herein, such as apparatus 105, 205, and/or 305. In some embodiments, logic flow 400 may be representative of some or all of the operations of a memory allocation portion of a memory operation verification process according to some embodiments.

At block 402, logic flow 400 may receive a memory allocation instruction. For example, an application 140a-n may trigger a memory allocation (for instance, a malloc function call) via memory controller 120 for memory device 130. Logic flow 400 may allocate a memory element in a memory unit at block 404. For example, a heap block 246a-n may be allocated in heap 240. At block 406, logic flow 400 may determine a memory identifier for the memory unit. For example, memory operation logic 225 may determine a HID 250a-n for a heap block 246a-n. In some embodiments, memory operation logic 225 may access or determine the previously-assigned HID, such as in a HID table, and add the increment step to the previously-assigned HID to determine the next HID value. In some embodiments, the HID may be a random number and not an increment based on a previously-assigned value. At block 408, logic flow 400 may generate a pointer for memory unit. For example, a pointer for the memory element may be generated as part of the memory allocation process, such as p1 in the following pseudocode: char* p1=(char*)malloc (SIZE). Logic flow may generate a memory pointer structure based on the pointer and the memory identifier at block 410. For instance, memory operation logic 225 may define a pointer structure the pseudocode (2) provided above. Accordingly, memory allocation in a memory unit may cause logic flow 400 to establish conditions based on the use of memory identifiers for preventing a use-after-free event.

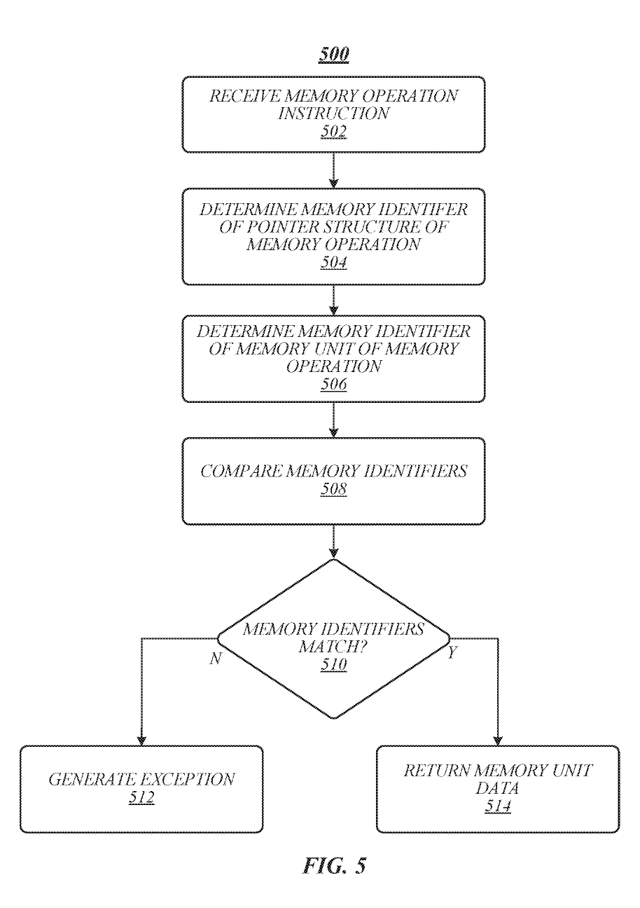

FIG. 5 illustrates an embodiment of a logic flow 500. Logic flow 500 may be representative of some or all of the operations executed by one or more embodiments described herein, such as apparatus 105, 205, and/or 305. In some embodiments, logic flow 500 may be representative of some or all of the operations of a memory operation verification process.

At block 502, logic flow 500 may receive a memory operation instruction 502. For example, memory operation logic may receive a memory operation 380 to access a portion of heap 340. Logic flow 500 may determine a memory identifier of a pointer structure of memory operation at block 504. For example, a memory operation verification process 382 may determine an HID 350x associated with pointer 372. At block 506, logic flow 500 may determine a memory identifier of the memory unit of the memory operation. For example, memory operation verification process 382 may access an HID 350a of heap block 346, which is the subject of the memory operation 380. At block 508, logic flow 500 may compare the memory identifiers. For example, memory operation verification process 382 may compare HID 350x to HID 350a. Logic flow 500 may determine whether the memory identifiers match at block 510. At block 512, logic flow may generate an exception of the memory identifiers do not match. For example, memory operation verification process 382 may determine that HID 350x does not match HID 350a. Accordingly, memory operation verification process 382 may determine that memory operation 380 may be or may be a part of a use-after-free event. Memory operation verification process 382 may not provide access to heap block 346 and, instead, may generate an exception as part of a memory corruption event 386.

At block 514, logic flow 500 may return memory data unit if the memory identifiers match. For example, if HID 350x matches HID 350a, memory operation verification process 382 may determine that memory operation 380 is valid for pointer 372 (for instance, memory operation 380 is not a use-after-free event) and may return 384 data element 352 to the calling function of memory operation 380.

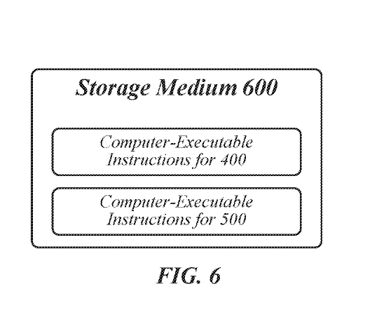

FIG. 6 illustrates an example of a storage medium 600. Storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 400 and 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

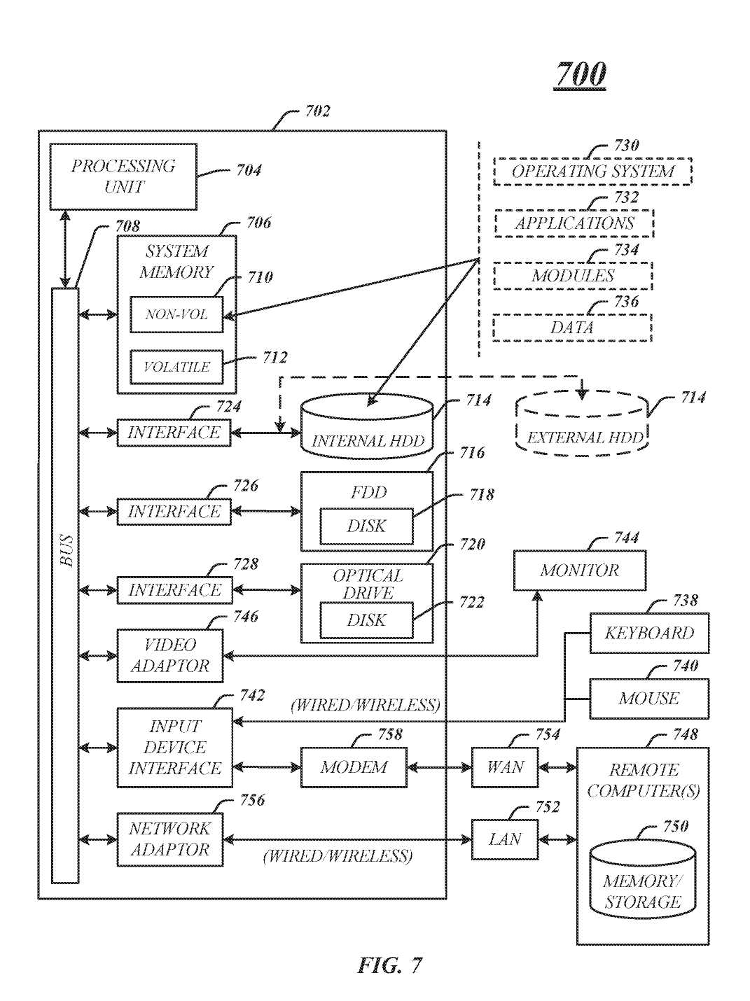

FIG. 7 illustrates an embodiment of an exemplary computing architecture 700 suitable for implementing various embodiments as previously described. In various embodiments, the computing architecture 700 may comprise or be implemented as part of an electronic device. In some embodiments, the computing architecture 700 may be representative, for example, of apparatus 105, 205, and/or 305. The embodiments are not limited in this context.

As used in this application, the terms “system” and “component” and “module” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 comprises a processing unit 704, a system memory 706 and a system bus 708. The processing unit 704 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 704.

The system bus 708 provides an interface for system components including, but not limited to, the system memory 706 to the processing unit 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1384 interface technologies.

The drives and associated computer-readable media provide volatile and/or nonvolatile storage of data, data structures, computer-executable instructions, and so forth. For example, a number of program modules can be stored in the drives and memory units 710, 812, including an operating system 730, one or more application programs 732, other program modules 734, and program data 736. In one embodiment, the one or more application programs 732, other program modules 734, and program data 736 can include, for example, the various applications and/or components of apparatus 105, 205, and/or 305.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 704 through an input device interface 742 that is coupled to the system bus 708, but can be connected by other interfaces such as a parallel port, IEEE 1384 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The following include non-limiting example embodiments:

Example 1 is an apparatus, comprising at least one memory comprising at least one memory unit, and logic coupled to the at least one memory, the logic to implement a memory operation verification process to allocate a memory element in the at least one memory unit, generate a pointer for the memory element, determine a memory identifier, and assign the memory identifier to the memory element and the pointer.

Example 2 is the apparatus of example 1, the at least one memory unit comprising a heap memory.

Example 3 is the apparatus of example 2, the memory element comprising a heap block.

Example 4 is the apparatus of example 1, the memory operation verification process to prevent a use-after-free event.

Example 5 is the apparatus of example 1, the logic to implement the memory operation verification process to generate a pointer structure comprising the pointer and the memory identifier.

Example 6 is the apparatus of example 1, the memory identifier comprising a 16-bit integer.

Example 7 is the apparatus of example 1, the logic to implement the memory operation verification process to allocate a second memory element in the at least one memory unit, determine a second memory identifier, and assign the second memory identifier to the second memory element.

Example 8 the apparatus of example 1, the logic to implement the memory operation verification process to allocate a second memory element in the at least one memory unit, generate a second pointer for the memory element, determine a second memory identifier, and assign the second memory identifier to the second pointer.

Example 9 is the apparatus of example 1, the logic to implement the memory operation verification process to determine a second memory identifier for a second memory element allocated in the at least one memory unit, the second memory identifier comprising the memory identifier incremented by an increment step.

Example 10 is the apparatus of example 1, the logic to implement the memory operation verification process to receive a memory operation to access the memory element, determine a pointer memory identifier associated with a pointer of the memory operation, and determine an element memory identifier associated with a memory element of the memory operation.

Example 11 is the apparatus of example 8, the logic to implement the memory operation verification process to provide data of the memory element responsive to a determination that the pointer memory identifier matches the element memory identifier.

Example 12 is the apparatus of example 8, the logic to implement the memory operation verification process to trigger a memory corruption event responsive to a determination that the pointer memory identifier does not match the element memory identifier.

Example 13 is the apparatus of example 1, the logic to store the memory identifier in a memory identifier table in the at least one memory.

Example 14 is the apparatus of example 1, the at least one memory unit comprising a heap memory, the logic to store the memory identifier in a memory identifier table in a header of the heap memory.

Example 15 is a system, comprising the apparatus according to any of examples 1-14, and at least one network interface.

Example 16 is a method, comprising allocating a memory element in at least one memory unit of a computing device, generating a pointer for the memory element, and providing a memory operation verification process to determine a memory identifier, and assign the memory identifier to the memory element and the pointer.

Example 17 is the method of example 15, the at least one memory unit comprising a heap memory.

Example 18 is the method of example 17, the memory element comprising a heap block.

Example 19 is the method of example 15, the memory operation verification process to prevent a use-after-free event.

Example 20 is the method of example 15, comprising providing the memory operation verification process to generate a pointer structure comprising the pointer and the memory identifier.

Example 21 is the method of example 15, the memory identifier comprising a 16-bit integer.

Example 22 is the method of example 15, comprising providing the memory operation verification process to allocate a second memory element in the at least one memory unit, determine a second memory identifier, and assign the second memory identifier to the second memory element.

Example 23 is the method of example 15, comprising providing the memory operation verification process to allocate a second memory element in the at least one memory unit, generate a second pointer for the memory element, determine a second memory identifier, and assign the second memory identifier to the second pointer.

Example 24 is the method of example 15, comprising providing the memory operation verification process to determine a second memory identifier for a second memory element allocated in the at least one memory unit, the second memory identifier comprising the memory identifier incremented by an increment step.

Example 25 is the method of example 15, comprising providing the memory operation verification process to receive a memory operation to access the memory element, determine a pointer memory identifier associated with a pointer of the memory operation, and determine an element memory identifier associated with a memory element of the memory operation.

Example 26 is the method of example 25, comprising providing the memory operation verification process to provide data of the memory element responsive to a determination that the pointer memory identifier matches the element memory identifier.

Example 27 is the method of example 25, comprising providing the memory operation verification process to trigger a memory corruption event responsive to a determination that the pointer memory identifier does not match the element memory identifier.

Example 28 is the method of example 15, comprising storing the memory identifier in a memory identifier table in the at least one memory.

Example 29 is the method of example 15, the at least one memory unit comprising a heap memory, comprising storing the memory identifier in a memory identifier table in a header of the heap memory.

Example 30 is a computer-readable storage medium, comprising a plurality of instructions that, when executed, enable processing circuitry of a computing device to implement a memory operation verification process to allocate a memory element in at least one memory unit of the computing device, generate a pointer for the memory element, determine a memory identifier, and assign the memory identifier to the memory element and the pointer.

Example 31 is the computer-readable storage medium of example 30, the at least one memory unit comprising a heap memory.

Example 33 is the computer-readable storage medium of example 31, the memory element comprising a heap block.

Example 33 is the computer-readable storage medium of example 30, the memory operation verification process to prevent a use-after-free event.

Example 34 is the computer-readable storage medium of example 30, the instructions, when executed, to enable processing circuitry of the computing device to implement the memory operation verification process to generate a pointer structure comprising the pointer and the memory identifier.

Example 35 is the computer-readable storage medium of example 30, the memory identifier comprising a 16-bit integer.

Example 36 is the computer-readable storage medium of example 30, the instructions, when executed, to enable processing circuitry of the computing device to implement the memory operation verification process to allocate a second memory element in the at least one memory unit, determine a second memory identifier, and assign the second memory identifier to the second memory element.

Example 37 is the computer-readable storage medium of example 30, the instructions, when executed, to enable processing circuitry of the computing device to implement the memory operation verification process to allocate a second memory element in the at least one memory unit, generate a second pointer for the memory element, determine a second memory identifier, and assign the second memory identifier to the second pointer.

Example 38 is the computer-readable storage medium of example 30, the instructions, when executed, to enable processing circuitry of the computing device to implement the memory operation verification process to determine a second memory identifier for a second memory element allocated in the at least one memory unit, the second memory identifier comprising the memory identifier incremented by an increment step.

Example 39 is the computer-readable storage medium of example 30, the instructions, when executed, to enable processing circuitry of the computing device to implement the memory operation verification process to receive a memory operation to access the memory element, determine a pointer memory identifier associated with a pointer of the memory operation, and determine an element memory identifier associated with a memory element of the memory operation.

Example 40 is the computer-readable storage medium of example 39, the instructions, when executed, to enable processing circuitry of the computing device to implement the memory operation verification process to provide data of the memory element responsive to a determination that the pointer memory identifier matches the element memory identifier.

Example 41 is the computer-readable storage medium of example 39, the instructions, when executed, to enable processing circuitry of the computing device to implement the memory operation verification process to trigger a memory corruption event responsive to a determination that the pointer memory identifier does not match the element memory identifier.

Example 42 is the computer-readable storage medium of example 30, the instructions, when executed, to enable processing circuitry of the computing device to store the memory identifier in a memory identifier table in the at least one memory.

Example 43 is the computer-readable storage medium of example 30, the at least one memory unit comprising a heap memory, the instructions, when executed, to enable processing circuitry of the computing device to store the memory identifier in a memory identifier table in a header of the heap memory.

Example 44 is an apparatus, comprising a memory allocation means to allocate a memory element in the at least one memory unit, and generate a pointer for the memory element, and a memory operation verification means to determine a memory identifier, and assign the memory identifier to the memory element and the pointer.

Example 45 is the apparatus of example 44, the at least one memory unit comprising a heap memory.

Example 46 is the apparatus of example 45, the memory element comprising a heap block.

Example 47 is the apparatus of example 44, the memory operation verification process means to prevent a use-after-free event.

Example 48 is the apparatus of example 44, the memory operation verification means to generate a pointer structure comprising the pointer and the memory identifier.

Example 49 is the apparatus of example 44, the memory identifier comprising a 16-bit integer.

Example 50 is the apparatus of example 44, the memory allocation means to allocate a second memory element in the at least one memory unit, and the memory operation verification means to determine a second memory identifier, and assign the second memory identifier to the second memory element.

Example 51 is the apparatus of example 44, the memory allocation means to allocate a second memory element in the at least one memory unit, and generate a second pointer for the memory element, and the memory operation verification means to determine a second memory identifier, and assign the second memory identifier to the second pointer.

Example 52 is the apparatus of example 44, the memory operation verification means to determine a second memory identifier for a second memory element allocated in the at least one memory unit, the second memory identifier comprising the memory identifier incremented by an increment step.

Example 53 is the apparatus of example 44, the memory operation verification means to receive a memory operation to access the memory element, determine a pointer memory identifier associated with a pointer of the memory operation, and determine an element memory identifier associated with a memory element of the memory operation.

Example 54 is the apparatus of example 53, the memory operation verification means to provide data of the memory element responsive to a determination that the pointer memory identifier matches the element memory identifier.

Example 55 is the apparatus of example 53, the memory operation verification means to trigger a memory corruption event responsive to a determination that the pointer memory identifier does not match the element memory identifier.

Example 56 is the apparatus of example 44, the memory operation verification means to store the memory identifier in a memory identifier table in the at least one memory.

Example 57 is the apparatus of example 44, the at least one memory unit comprising a heap memory, the memory operation verification means to store the memory identifier in a memory identifier table in a header of the heap memory.

Example 58 is a system, comprising the apparatus according to any of examples 44-57, and at least one network interface.

It should be noted that the methods described herein do not have to be executed in the order described, or in any particular order. Moreover, various activities described with respect to the methods identified herein can be executed in serial or parallel fashion.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. It is to be understood that the above description has been made in an illustrative fashion, and not a restrictive one. Combinations of the above embodiments, and other embodiments not specifically described herein will be apparent to those of skill in the art upon reviewing the above description. Thus, the scope of various embodiments includes any other applications in which the above compositions, structures, and methods are used.

It is emphasized that the Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment. In the appended claims, the terms “including” and “in which” are used as the plain-English equivalents of the respective terms “comprising” and “wherein,” respectively. Moreover, the terms “first,” “second,” and “third,” etc. are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus, comprising:
at least one memory comprising at least one memory unit; and
logic coupled to the at least one memory, the logic to implement a memory operation verification process to:
allocate a memory element in the at least one memory unit,
generate a pointer for the memory element,
determine a memory identifier, and
assign the memory identifier to the memory element and the pointer.

2. The apparatus of claim 1, the at least one memory unit comprising a heap memory.

3. The apparatus of claim 1, the memory operation verification process to prevent a use-after-free event.

4. The apparatus of claim 1, the logic to implement the memory operation verification process to generate a pointer structure comprising the pointer and the memory identifier.

5. The apparatus of claim 1, the memory identifier comprising a 16-bit integer.

6. The apparatus of claim 1, the logic to implement the memory operation verification process to:
allocate a second memory element in the at least one memory unit,
determine a second memory identifier, and
assign the second memory identifier to the second memory element.

7. The apparatus of claim 1, the logic to implement the memory operation verification process to:
allocate a second memory element in the at least one memory unit,
generate a second pointer for the memory element,
determine a second memory identifier, and
assign the second memory identifier to the second pointer.

8. The apparatus of claim 1, the logic to implement the memory operation verification process to:
receive a memory operation to access the memory element,
determine a pointer memory identifier associated with a pointer of the memory operation, and
determine an element memory identifier associated with a memory element of the memory operation.

9. The apparatus of claim 8, the logic to implement the memory operation verification process to provide data of the memory element responsive to a determination that the pointer memory identifier matches the element memory identifier.

10. The apparatus of claim 8, the logic to implement the memory operation verification process to trigger a memory corruption event responsive to a determination that the pointer memory identifier does not match the element memory identifier.

11. A method, comprising:
allocating a memory element in at least one memory unit of a computing device;
generating a pointer for the memory element; and
providing a memory operation verification process to:
determine a memory identifier, and
assign the memory identifier to the memory element and the pointer.

12. The method of claim 11, the at least one memory unit comprising a heap memory.

13. The method of claim 11, the memory operation verification process to prevent a use-after-free event.

14. The method of claim 11, comprising providing the memory operation verification process to generate a pointer structure comprising the pointer and the memory identifier.

15. The method of claim 11, the memory identifier comprising a 16-bit integer.

16. The method of claim 11, comprising providing the memory operation verification process to:
allocate a second memory element in the at least one memory unit,
determine a second memory identifier, and
assign the second memory identifier to the second memory element.

17. The method of claim 11, comprising providing the memory operation verification process to:
allocate a second memory element in the at least one memory unit;
generate a second pointer for the memory element;
determine a second memory identifier; and
assign the second memory identifier to the second pointer.

18. The method of claim 11, comprising providing the memory operation verification process to:
receive a memory operation to access the memory element,
determine a pointer memory identifier associated with a pointer of the memory operation, and
determine an element memory identifier associated with a memory element of the memory operation.

19. The method of claim 18, comprising providing the memory operation verification process to provide data of the memory element responsive to a determination that the pointer memory identifier matches the element memory identifier.

20. The method of claim 18, comprising providing the memory operation verification process to trigger a memory corruption event responsive to a determination that the pointer memory identifier does not match the element memory identifier.

21. A computer-readable storage medium, comprising a plurality of instructions that, when executed, enable processing circuitry of a computing device to implement a memory operation verification process to:
allocate a memory element in at least one memory unit of the computing device;
generate a pointer for the memory element;
determine a memory identifier; and
assign the memory identifier to the memory element and the pointer.

22. The computer-readable storage medium of claim 21, the memory operation verification process to prevent a use-after-free event.

23. The computer-readable storage medium of claim 21, the instructions, when executed, to enable processing circuitry of the computing device to implement the memory operation verification process to generate a pointer structure comprising the pointer and the memory identifier.

24. The computer-readable storage medium of claim 21, the instructions, when executed, to enable processing circuitry of the computing device to implement the memory operation verification process to:
allocate a second memory element in the at least one memory unit,
determine a second memory identifier, and
assign the second memory identifier to the second memory element.

25. The computer-readable storage medium of claim 21, the instructions, when executed, to enable processing circuitry of the computing device to implement the memory operation verification process to:
receive a memory operation to access the memory element,
determine a pointer memory identifier associated with a pointer of the memory operation, and
determine an element memory identifier associated with a memory element of the memory operation.
